(19) United States
(12) Patent Application Publication
(10) Pub. No.: US 2023/0230070 A1
(43) Pub. Date: Jul. 20, 2023

(54) INTEGRATED MOBILE WALLET SYSTEMS AND METHODS

(71) Applicant: Wells Fargo Bank, N.A., San Francisco, CA (US)

(72) Inventor: Ashish B. Kurani, Burlingame, CA (US)

(21) Appl. No.: 14/862,905

(22) Filed: Sep. 23, 2015

Related U.S. Application Data
(60) Provisional application No. 62/135,556, filed on Mar. 19, 2015.

(51) Int. Cl. G06Q 20/36; G06Q 20/24; G06Q 20/38; G06Q 20/32; G06Q 20/40

(52) U.S. Cl. CPC G06Q 20/3672; G06Q 20/24; G06Q 20/3829; G06Q 20/322; G06Q 20/405; G06Q 2220/00

(57) ABSTRACT

Systems and methods for facilitating card transactions via a mobile wallet on a user's mobile device are described. More particularly, the present disclosure relates to the use of codes with network tokens for validation during payment processing. The codes may be transmitted optically (e.g., by presenting a two-dimensional barcode or three-dimensional barcode on a display of the mobile device that is scanned by a POS terminal) or wirelessly (e.g., via near-field communication (“NFC”), Bluetooth®, Wi-Fi®, etc.). The mobile wallet is implemented on the user's mobile device (e.g., the user's smartphone) and is associated with a financial institution. The mobile wallet may utilize credit and debit cards issued by the financial institution or by another financial institution. Generally, the mobile wallet system utilizes host card emulation via a network-generated token that is processed by the network to complete the contemplated transaction.

### CROSS-REFERENCE TO RELATED APPLICATIONS

This application claims priority to U.S. Provisional Patent Application No. 62/135,556, entitled “Integrated Mobile Wallet Systems and Methods,” filed on Mar. 19, 2015, which is herein incorporated by reference in its entirety and for all purposes. This application is related to U.S. application Ser. No. 14/501,907, entitled “Mobile Wallet Integration within Mobile Banking,” filed on Sep. 30, 2014 and U.S. application Ser. No. 14/471,920, entitled “Mobile Wallet Using Tokenized Card Systems and Methods,” filed on Aug. 28, 2014, both of which are continuations-in-part of U.S. application Ser. No. 14/266,580, entitled “Mobile Wallet Using Tokenized Card Systems and Methods,” filed on Apr. 30, 2014. Each of the above-identified applications are incorporated by reference herein in their entireties and for all purposes.

### TECHNICAL FIELD

The present disclosure relates generally to the field of using mobile devices, such as a smartphone, to effect a transfer of funds. More specifically, the present disclosure relates to systems and methods for enabling individuals to use their electronic devices at a point-of-sale system to pay for purchases of products and services from merchants.

### BACKGROUND

Payments for products and services are often completed using credit cards, debit cards, checks, or cash. Generally, when completing a card transaction (e.g., debit card, credit card, gift card, etc.) at a brick-and-mortar merchant location, a person first locates their wallet, identifies which card from a plurality of card he wants to use for the purchase, swipes the card at a point of sale (“POS”) terminal, and signs for the transaction. At the same time, most people carry some type of mobile handheld electronic device, such as a cellular phone, smart phone, mobile handheld wireless e-mail device, personal digital assistant, portable gaming devices, and so on. Many of these devices have a wireless Internet connection. A person may wish to make payments to merchants using these mobile devices instead of having to also carry around a wallet. Accordingly, enhanced systems and methods of facilitating such transactions would be desirable.

### SUMMARY

One example embodiment relates to a method of providing a user a mobile wallet system hosted by a financial institution. The method includes receiving, at a financial institution computing system, a registration request from a user via a mobile device associated with the user. The method further includes creating, by the financial institution computing system, a mobile wallet account associated with the user. The method includes receiving, by the financial institution computing system, credit card information associated with a credit card account held by the user. The method further includes transmitting, by the financial institution computing system, the credit card information to a payment network computing system. The method includes receiving, by the financial institution computing system, a payment token and a limited use key associated with the credit card information from the payment network computing system.

Another example embodiment relates to a computing system associated with a financial institution. The computing system includes a mobile wallet database having mobile wallet account information relating to users of a mobile wallet system provided by the financial institution. The computing system further includes an account database having customer account information associated with financial products other than the mobile wallet system. The computing system includes a network interface configured to communicate data to and from a payment network computing system and a mobile device associated with a user over a network. The computing system further includes memory and a processor. The processor is configured to receive a registration request from the user via the mobile device, wherein the mobile device is associated with the user. The processor is further configured to create a mobile wallet account associated with the user. The processor is configured to receive credit card information associated with a credit card account held by the user. The processor is further configured to transmit the credit card information to the payment network computing system. The processor is configured to receive a payment token and a limited use key associated with the credit card information from the payment network computing system.

A further example embodiment relates to a non-transitory computer-readable media having computer-executable instructions embodied therein that, when executed by a processor of a financial institution computing system associated with a financial institution that provides a mobile wallet system, cause the financial institution computing system to perform a process. The process includes receiving a registration request from a user via a mobile device associated with the user, and creating a mobile wallet account associated with the user. The process further includes receiving credit card information associated with a credit card account held by the user. The process includes transmitting the credit card information to a payment network computing system. The process further includes receiving a payment token and a limited use key associated with the credit card information from the payment network computing system.

These and other features, together with the organization and manner of operation thereof, will become apparent from the following detailed description when taken in conjunction with the accompanying drawings, wherein like elements have like numerals throughout the several drawings described below.

### BRIEF DESCRIPTION OF THE FIGURES

FIG. 1 is a block diagram of a computing environment for facilitating mobile wallet payments according to an example embodiment.

FIG. 2 is a flow diagram of a method of registering a user for the mobile wallet system operating in the computer environment of FIG. 1.

FIG. 3 is a flow diagram of a method of automatically refreshing limited use keys associated with a user account according to an example embodiment.

FIG. 4 is a flow diagram of a method of registering a new device with an existing mobile wallet account of a user is shown according to an example embodiment.

FIG. 5 is a flow diagram of a method of executing a payment associated with a transaction via the mobile wallet system is shown according to an example embodiment.

### DETAILED DESCRIPTION

Before turning to the figures which illustrate example embodiments, it should be understood that the application is not limited to the details or methodology set forth in the following description or illustrated in the figures. It should also be understood that the phraseology and terminology employed herein is for the purpose of description only and should not be regarded as limiting.

Referring generally to the figures, systems and methods for facilitating card transactions via a mobile wallet on a user's mobile device are described. More particularly, the present disclosure relates to the use of codes with network tokens for validation during payment processing. The codes may be transmitted optically (e.g., by presenting a two-dimensional barcode or three-dimensional barcode on a display of the mobile device that is scanned by a POS terminal) or wirelessly (e.g., via near-field communication (“NFC”), Bluetooth®, Wi-Fi®, etc.). The mobile wallet is implemented on the user's mobile device (e.g., the user's smartphone) and is associated with a financial institution. The mobile wallet may utilize credit and debit cards issued by the financial institution or by another financial institution. Generally, the mobile wallet system utilizes host card emulation via a network-generated token that is processed by the network to complete the contemplated transaction. These concepts are described in further detail below and are described in Appendix A to this application.

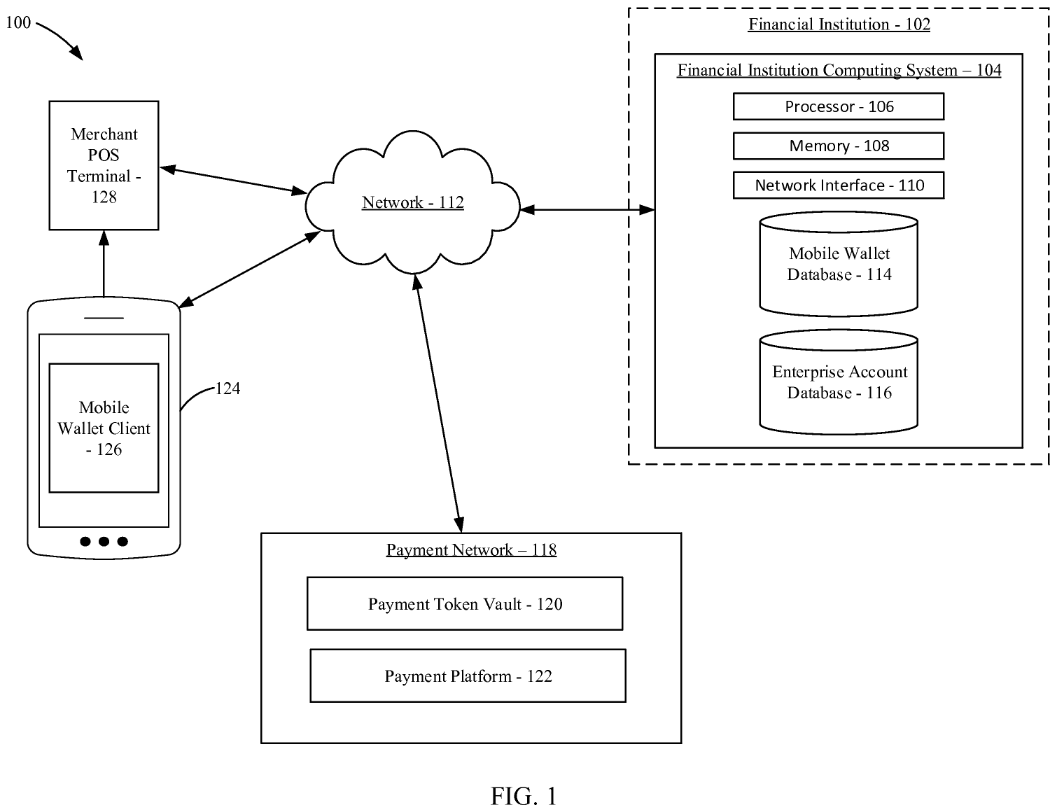

Referring to FIG. 1, a diagram of a computing environment 100 is shown according to an example embodiment. The computing environment 100 facilitates payment from a customer to a merchant via a mobile wallet hosted by a financial institution 102. The financial institution includes a financial institution computing system 104. In some arrangements, the financial institution computing system 104 is a mobile wallet server that facilitates operation of the mobile wallet provided by the financial institution 102. The financial institution computing system 104 includes a processor 106 and memory 108. Memory 108 stores various program modules that, when executed by the processor 106, control the operation of the financial institution computing system 104. The financial institution computing system 104 includes a network interface 110. The network interface allows the financial institution computing system 104 to send and receive data to and from external devices and entities via a network 112.

The financial institution computing system 104 includes various databases. The financial institution computing system 104 includes a mobile wallet database 114. The mobile wallet database 114 stores mobile wallet account information relating to users of the mobile wallet system. The account information includes user authentication information (e.g., username/password combinations, device authentication tokens, security question answers, etc.) and mobile wallet account information (e.g., stored credit card information, payment tokens, etc.). The financial institution computing system 104 includes an enterprise account database 116. The enterprise account database 116 stores information relating to other financial products and services offered by the financial institution 102. The other financial products and services may include, for example, demand deposit account information, credit card information, debit card information, and the like. In some situations, the information in the enterprise account database 116 may be used to populate certain information, such as credit card information, in the mobile wallet database 114.

The computing environment 100 includes a payment network 118. In some arrangements, the payment network 118 is a financial institution that guarantees credit and debit card transactions (e.g., a credit card association, a credit card issuer, etc.). The payment network 118 includes a payment token vault 120 that stores generated payment tokens (e.g., network tokens) that are passed during transactions. The payment network 118 includes a payment platform 122. As described in further detail below, the payment platform 122 facilitates mobile wallet payments via stored payment tokens that are used to link pending purchases by users of the mobile wallet system to a specific user and a specific payment method stored within the mobile wallet system. In some arrangements, the payment network 118 is embodied as a computing system or server.

Generally, the computing environment 100 facilitates electronic and card-less payments of a mobile wallet user to a merchant through host card emulation (“HCE”). A user attempting to make a purchase at a merchant will pass a payment token that emulates a card from a mobile device 124 running a mobile wallet client 126 to a POS terminal 128. The mobile device 124 may be a smartphone, a portable media device, a tablet computing device, a PDA, or the like. The mobile wallet client 126 is a mobile application (e.g., a smartphone application) configured to communicate with the financial institution computing system 104 via the network 112. The mobile wallet client 126 is also configured to communicate with the merchant POS terminal 128. In some arrangements, the mobile wallet client 126 wirelessly communicates with the merchant POS terminal 128, such as through an NFC transmitter of the mobile device 124. In other arrangements, the mobile wallet client 126 communicates with the merchant POS terminal 128 by presenting barcodes (e.g., two-dimensional barcodes or three-dimensional barcodes) on a display of the mobile device 124 that are scanned by a scanner of the merchant POS terminal 128. The merchant POS terminal 128 communicates information received from the mobile wallet client 126, notably a payment token or a payment token locator, to the payment network 118 for authorization to proceed with the contemplated transaction. In order to facilitate the transaction, the mobile wallet client 126 may include both programming modules from both the financial institution 102 that enables the mobile wallet client 126 to communicate data to and from the financial institution computing system 104 and programming modules from the payment network 118 (e.g., a software development kit associated with the payment platform 122).

The network 112 facilitates communication between the above-noted devices and entities. The network 112 may include private networks, public networks, or a combination thereof. In some arrangements, the network 112 includes the Internet.

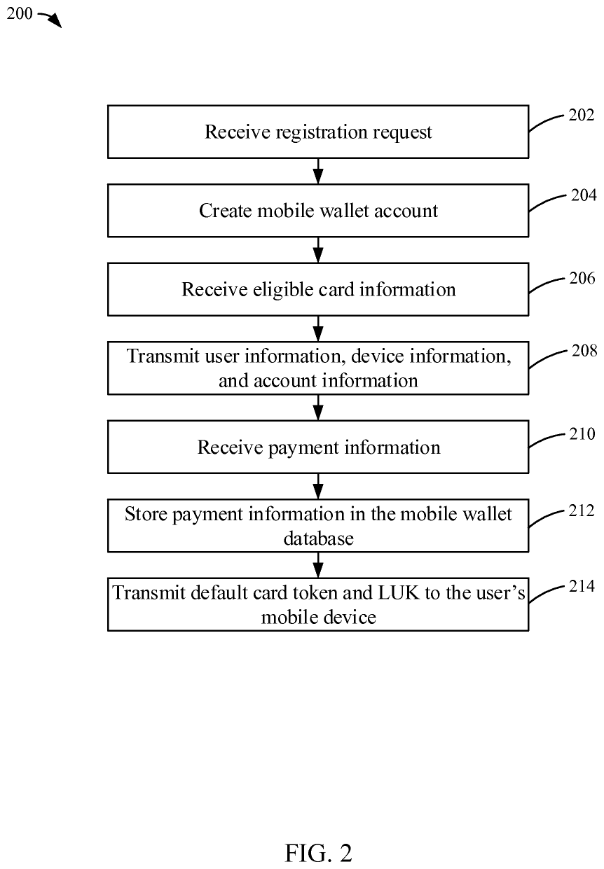

Referring to FIG. 2, a flow diagram of a method 200 of registering a user for the above-described mobile wallet system hosted by the financial institution 102 is described according to an example embodiment. In some arrangements, the user registering for the mobile wallet system must meet three preregistration conditions: (1) the user must be eligible for the mobile wallet system hosted by the financial institution (e.g., be a registered customer or account holder of the financial institution); (2) the user must have a valid mobile device 124 (e.g., a mobile device having an operating system that is compatible with the mobile wallet client 126, an NFC and HCE enabled mobile device, etc.); and (3) the user is registering during an authenticated mobile banking session. Method 200 is performed by the processor 106 of the financial institution computing system 104.

Method 200 begins when a request to register for the mobile wallet is received at 202. The request is received at the financial institution computing system 104. The request is received from a user via the mobile device 124. The request may be received during a secure mobile banking session between the user and the financial institution 102. The request includes user identification information (e.g., a username). Based on the user information, the financial institution computing system 104 retrieves the user's profile (e.g., from the enterprise account database 116 or another account database). The request to register also includes mobile device information relating to the mobile device 124. The mobile device information may relate to a mobile device identifier (e.g., a serial number, an FCC identifier, an international mobile station equipment identity, etc.). The mobile device identifier is used by the financial institution computing system 104 to pair the device to the user.

A mobile wallet account is created at 204. Based on the information received with the request at 202, the financial institution computing system 104 creates a mobile wallet account for the user. Creating the account may include generating a unique user account number. Additionally, creating the account may include assigning (or allowing the user to select) a mobile wallet access code (“WAC”). The WAC is entered by the user when logging into the mobile wallet client 126. For example, the mobile wallet client 126 may be configured to automatically open if the mobile device 124 approaches a merchant POS terminal 128 (e.g., based on detected NFC signals emitted by the merchant POS terminal 128). As an added security measure, the user may be prompted to enter the WAC prior to allowing the user to view the mobile wallet client 126 or prior to the mobile wallet client 126 transmitting payment information to the merchant POS terminal 128 to prevent unauthorized purchases or to prevent a fraudster from stealing the payment information. Additionally, a customer token and device token may be generated that are specific to the customer and device. The device token is used to register the device and to link the device with the customer. The account information is stored in the mobile wallet database 114.

Eligible card information is received at 206. The financial institution computing system 104 receives eligible card information from at least one of two sources: directly from the user (via the mobile device 124) and/or from the enterprise account database 116. The user can provide eligible card information. For example, the user may load any credit cards or debit cards that the user may own into the user's mobile wallet by providing the card information (credit card number, expiration, card code verification number, billing address, etc.) to the financial institution computing system via the mobile wallet client. In some arrangements, the user can provide the card information by taking pictures of the cards that the user wants to associate with the mobile wallet client 126 (e.g., a photo of the front of the card and a photo of the back of the card) and upload the photos to the financial institution computing system 104. Additionally, the financial institution computing system 104 will scan the enterprise account database 116 to automatically populate the user's mobile wallet with card information from accounts held with the financial institution 102. For example, the financial institution computing system 104 will automatically populate the user's mobile wallet with a credit card issued by the financial institution 102 in the user's name based on information in the enterprise account database 116. For automatically pulled card information, the user may be presented with the option to not import identified card information into the user's mobile wallet. In some arrangements, the eligible card information is stored in the mobile wallet database 114.

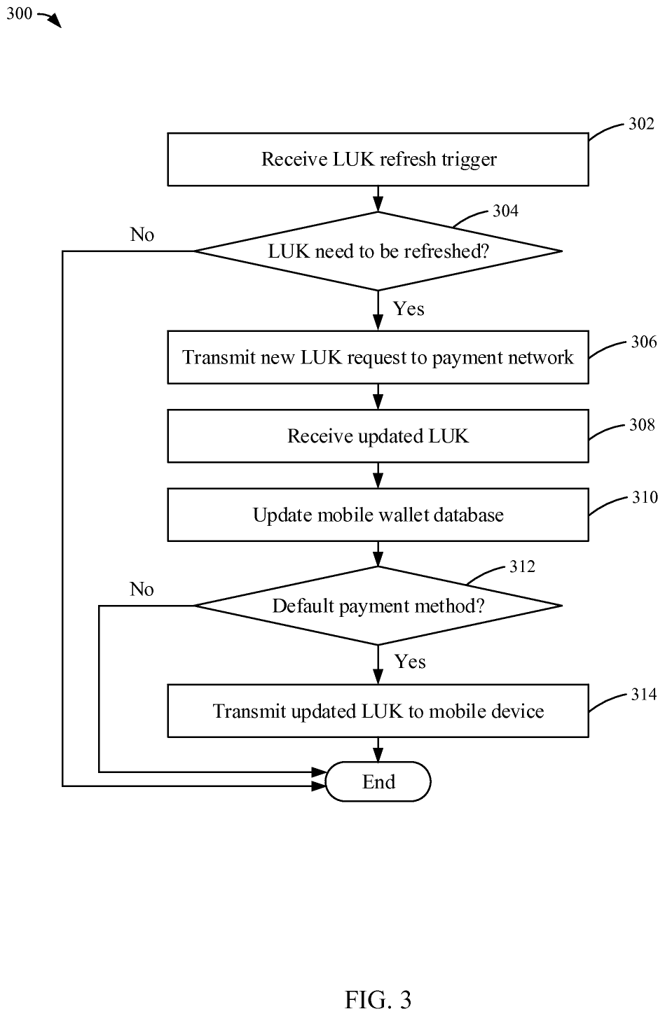

User information, device information, and account information is transmitted to the payment network 118 at 208. The financial institution computing system 104 transmits the information to the payment network 118. The payment network 118 utilizes the received user information to generate an access token that allows the financial institution 102 to access the payment network 118 to update payment information (i.e., credit card and debit card information). The payment network 118 utilizes the mobile device information (i.e., the user's mobile device 124 identifier) to register the device with the payment network 118 (which is later used to verify payment requests). The payment network 118 utilizes the account information, such as the eligible card information, to generate payment information that is transmitted from the mobile device 124 to the merchant POS terminal 128 during a transaction. The payment information for each card includes two parts: a unique payment token that identifies the card and a limited use key (“LUK”). The LUK is transmitted along with the payment token from the mobile device 124 to the merchant POS terminal 128 for each transaction. The LUK is an encrypted character string that is used by the mobile wallet client 126 to form a token cryptogram that is required for verification of the payment token. The token cryptogram is formed at least in part from the LUK based on cryptogram formation instructions and/or programming modules supplied by the payment network 118 that are incorporated into the mobile wallet client 126. The LUK has a limited use and expires. The LUK may expire after a predetermined period of time or after a predetermined number of uses. Accordingly, the LUK needs to be periodically refreshed (e.g., as discussed below with respect to FIG. 3). The payment information for each card (i.e., the token and LUK) is different for different devices. Accordingly, if a user registers two different devices for use with the same mobile wallet, the same card will have a different token and a different LUK for each device.

The payment information is received at 210. The financial institution computing system 104 receives the payment information from the payment network 118. The payment information includes any generated payment tokens, LUKs, and LUK expiration information for each payment card loaded into the mobile wallet system. The payment information is stored by the financial institution computing system 104 in the mobile wallet database 114 at 212.

The default card token and LUK is transmitted to the mobile device 124 at 214. The default card is identified by the user from the plurality of cards loaded at 206. The financial institution computing system 104 transmits the payment token and LUK associated with the default payment method (as selected by the user) to the mobile wallet client 126 on the mobile device 124. By storing the default payment card token and LUK on the mobile device 124, transactions performed at the merchant POS terminal 128 are performed quicker than a traditional mobile wallet because the payment card token and LUK do not need to be provisioned from the payment network 118 or the financial institution 102. Any other tokens and LUKs associated with other payment methods (i.e., the non-default payment cards) are stored in the mobile wallet database 114 for later retrieval. The storing of the other payment methods on the financial institution computing system 104 instead of the mobile device 124 increases the security of the mobile wallet system. If the user loses his mobile device 124, these cards are not compromised as they are stored locally at the mobile device 124. Further, any of the data stored on in the financial institution computing system 104 or within the mobile wallet client 126 can be encrypted for added security. The financial institution computing system 104 can periodically poll the payment network 118 for updated LUKs as the LUKs expire and replace any expired or about to expire LUKs with new LUKs. Updated LUKs can also be sent to the user device 124 for the default payment method. This reduces the amount of time needed for the user to prepare for a given transaction (since the new LUK is already loaded ahead of the transaction). At this point, the user is able to pay for purchases via the mobile wallet client 126.

After the user is registered for the mobile wallet account, the financial institution 102 maintains the user's mobile wallet account. The financial institution computing system 104 performs various automated non-transaction tasks to ensure that the mobile wallet functions smoothly for the user, which results in quicker transaction times for both the user and the merchant. For example, the financial institution computing system 104 can determine when a user opens a new credit card with the financial institution 102, closes a credit card with the financial institution 102, or receives a new credit card number associated with a credit account (e.g., if the user lost his wallet or had his card stolen) with the financial institution. In situations where the user opens a new credit card, the financial institution 102 can initiate an alert to the user via the mobile wallet client 126 that asks the user if he wants to add the new credit card to the mobile wallet. If the user wishes to add the new credit card to the mobile wallet, the financial institution computing system 104 can repeat 206 through 212 of method 200 for the new card. In situations where a credit account is closed or a new credit card number is assigned, the mobile wallet computing system 104 can automatically either remove the closed credit card or communicate with the payment service 118 to obtain updated payment tokens and LUKs to account for the new credit card number.

Additionally, the financial institution 102 can refresh the LUKs for the various cards such that the user does not have to wait for a refresh at the time of a purchase. Referring to FIG. 3, a flow diagram of a method 300 of automatically refreshing LUKs associated with a user account is shown according to an example embodiment. Method 300 is performed by the processor 106 of the financial institution computing system 104.

Method 300 begins when an LUK refresh trigger is received at 302. In some arrangements, the LUK refresh trigger is an internal trigger generated by the financial institution computing system 104. The internal trigger may be initiated based on a known expiration of a given LUK. For example, if an LUK is set to expire in a set period of time (such as in an hour), the financial institution computing system 104 may initiate the LUK refresh trigger. In other arrangements, the LUK refresh trigger is an external trigger generated as a result of some action of the user on the mobile device 124. For example, the LUK refresh trigger may be the result of the user logging into the mobile wallet client 126 by entering the user's WAC or logging off the mobile wallet client 126.

Based on the trigger, the financial institution computing system 104 determines whether any of the LUKs associated with the user need to be refreshed at 304. An LUK that needs to be refreshed may be referred to as an out of band LUK. As discussed above, each LUK expires. A given LUK may expire after a predetermined number of uses, after a predetermined period of time since issuance, or after a predetermined time of inactivity. An expired LUK needs to be refreshed with the payment network 118 prior to the LUK being used with a payment token. If an expired LUK is used by the user to the merchant POS terminal 128, the user and merchant will experience delays resulting from refreshing the LUK prior to executing the transaction. Accordingly, the any LUK is expired or approaching expiration, the method continues to 306. If no LUKs need to be refreshed, method 300 ends.

If a LUK needs to be refreshed (as determined at 304), a new LUK request is transmitted to the payment network 118 at 306. The financial institution computing system 104 transmits a request for a new (i.e., refreshed) LUK for the payment method with the expired or about to expire LUK. In response to the requesting the new LUK, the payment network 118 generates and transmits a new LUK associated with the specific user device and payment source to the financial institution computing system 104. The new LUK is received at the financial institution computing system 104 at 308.

The mobile wallet database 114 is updated at 310. The financial institution computing system 104 updates the mobile wallet database 114 to reflect the new LUK. At 312, the financial institution computing system determines whether the new LUK corresponds with the user's default payment method. As discussed above, the user's default payment method has the associated token and LUK stored on the mobile device 124 to reduce lag while making payments. Accordingly, if the new LUK corresponds with the user's default payment method, the financial institution computing system 104 transmits the new LUK to the user's mobile device 124 at 314. In some arrangements, the financial institution computing system 104 transmits a command to the mobile wallet client 126 to remove the old LUK from the memory of the mobile device 124. If the new LUK does not correspond to the default payment method or after the new LUK is transmitted to the mobile device, method 300 ends. Method 300 repeats for each received LUK refresh trigger.

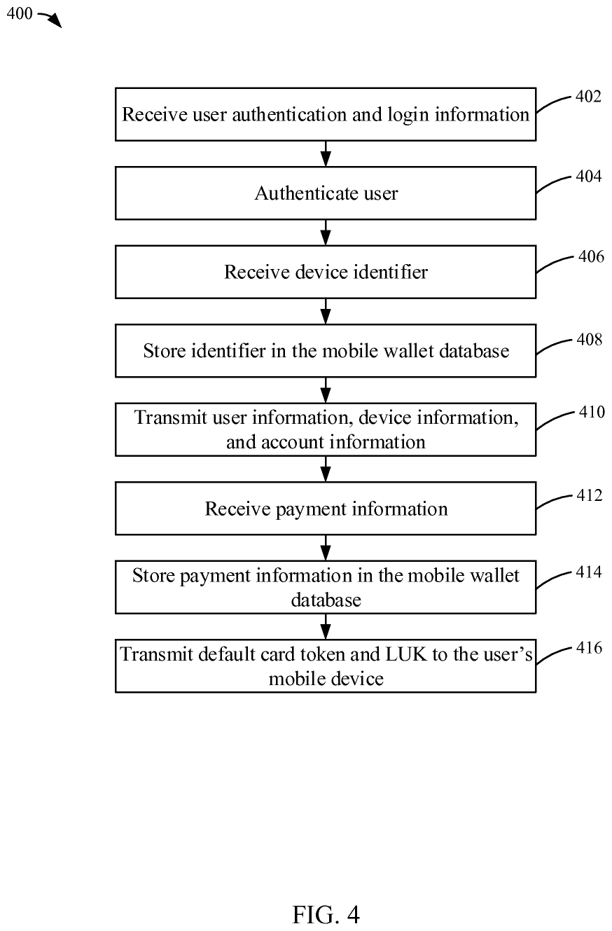

Referring to FIG. 4, a flow diagram of a method 400 of registering a new device (e.g., mobile device 124) with an existing mobile wallet account of a user is shown according to an example embodiment. In order to register a device with the mobile wallet system, three pre-conditions must be met: (1) the user associated with the device being registered must be a registered user of the mobile wallet system; (2) the user must have a valid mobile device 124 (e.g., a mobile device having an operating system that is compatible with the mobile wallet client 126, an NFC and HCE enabled mobile device, etc.); and (3) the user is registering the device during an authenticated mobile banking session. The method 400 is similar to the method 200 (described above with respect to FIG. 2). However, the method 400 does not include user registration steps because the use is already registered with the mobile wallet system. The method 400 is performed by financial institution computing system 104 (e.g., by the processor 106).

Method 400 begins when user login and authentication information is received at 402. The user login and authentication information is provided by the mobile wallet client 126 (or mobile banking application) running on the user's mobile device 124 that is being registered with the mobile wallet system. The user login and authentication information may relate to, for example, a username, a password, online banking credentials, the user's WAC, or a combination thereof. In some arrangements, the user login and authentication information also receives a device identifier that uniquely identifies the mobile device 124. The user login and authentication information is received by the financial institution computing system 104.

Based on the received user login and authentication information, the user is authenticated at 404. The financial institution computing system 104 compares the received user login and authentication information with stored and verified user login and authentication information stored in the mobile wallet database 114 and/or the enterprise account database 116. If the received user login and authentication information does not match, the user is not authenticated. If the received user login and authentication information matches the verified and stored user login and authentication information, the user is authenticated. Method 400 continues under the assumption that the user is authenticated.

A device identifier is received at 406. The financial institution computing system 104 receives the device identifier from the mobile device 124. The device identifier is a unique identifier that identifies the mobile device 124. In some arrangements, the device identifier is received with the user authentication and login information at 402. In such arrangements, step 406 is skipped.

The received device identifier is stored in the mobile wallet database 114 at 408. The financial institution computing system 104 associates the device identifier with the user's mobile wallet account as an authorized mobile device. After the mobile device 124 is associated with the user's mobile wallet account, the financial institution computing system 104 goes through similar steps of obtaining device-specific LUKs and payment tokens for the user's payment information as discussed above with respect to method 200—specifically with respect to 208-214.

Accordingly, user information, device information, and account information is transmitted to the payment network 118 at 410. The financial institution computing system 104 transmits the information to the payment network 118. The payment network 118 utilizes the received user information to generate an access token that allows the financial institution 102 to access the payment network 118 to update payment information (i.e., credit card and debit card information). The payment network 118 utilizes the mobile device information (i.e., the user's mobile device 124 identifier) to register the device with the payment network 118 (which is later used to verify payment requests). The payment network 118 utilizes the account information, such as the eligible card information, to generate payment information that is transmitted from the mobile device 124 to the merchant POS terminal 128 during a transaction. The payment information for each card includes two parts: a unique payment token that identifies the card and a limited use key (“LUK”). The LUK is transmitted along with the payment token from the mobile device 124 to the merchant POS terminal 128 for each transaction. The LUK is an encrypted character string that is attached to the token during the transaction. The LUK has a limited use and expires. The LUK may expire after a predetermined period of time or after a predetermined number of uses. The payment information for each card (i.e., the token and LUK) is different for different devices. Accordingly, if a user registers two different devices for use with the same mobile wallet, the same card will have a different token and a different LUK for each device.

The payment information is received at 412. The financial institution computing system 104 receives the payment information from the payment network 118. The payment information includes any generated payment tokens, LUKs, and LUK expiration information for each payment card loaded into the mobile wallet system. The payment information is stored by the financial institution computing system 104 in the mobile wallet database 114 at 414.

The default card token and LUK is transmitted to the mobile device 124 at 416. The default card is identified by the user from the plurality of cards loaded when the user initially registered with the mobile wallet system (e.g., at 206 of method 200). The financial institution computing system 104 transmits the payment token and LUK associated with the default payment method (as selected by the user) to the mobile wallet client 126 on the mobile device 124. By storing the default payment card token and LUK on the mobile device 124, transactions performed at the merchant POS terminal 128 are performed quicker than a traditional mobile wallet because the payment card token and LUK do not need to be provisioned from the payment network 118 or the financial institution 102. Any other tokens and LUKs associated with other payment methods (i.e., the non-default payment cards) are stored in the mobile wallet database 114 for later retrieval. The storing of the other payment methods on the financial institution computing system 104 instead of the mobile device 124 increases the security of the mobile wallet system. If the user loses his mobile device 124, these cards are not compromised as they are stored locally at the mobile device 124. Further, any of the data stored on in the financial institution computing system 104 or within the mobile wallet client 126 can be encrypted for added security. The financial institution computing system 104 can periodically poll the payment network 118 for updated LUKs as the LUKs expire and replace any expired or about to expire LUKs with new LUKs. Updated LUKs can also be sent to the user device 124 for the default payment method. This reduces the amount of time needed for the user to prepare for a given transaction (since the new LUK is already loaded ahead of the transaction). At this point, the user is able to pay for purchases via the mobile wallet client 126.

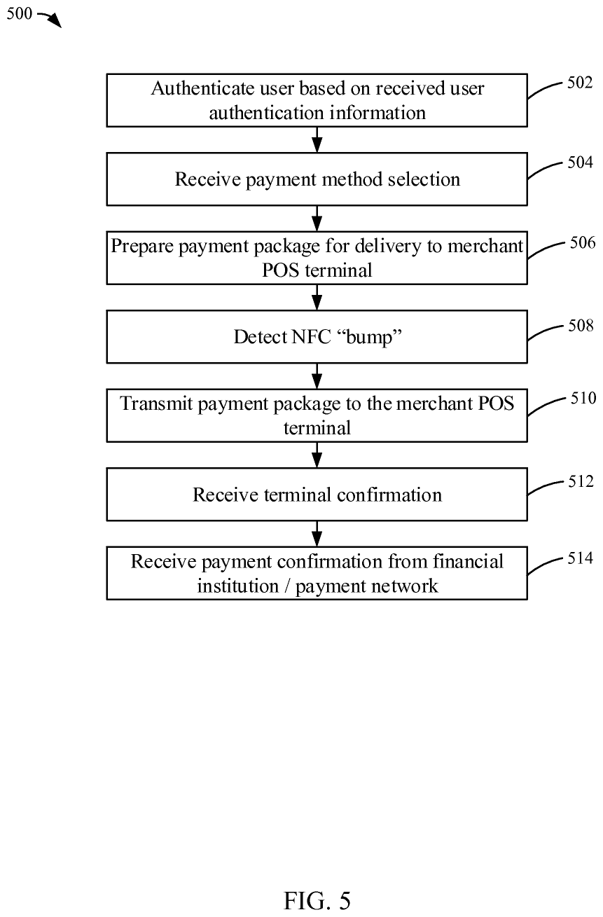

Generally, to make a payment via the mobile wallet system, the user first activates the mobile wallet client 126. In some arrangements, the mobile wallet client 126 automatically activates as the user approaches the merchant POS terminal 128 (e.g., when the mobile device is within wireless range of the merchant POS terminal 128). In other arrangements, the user manually opens the mobile wallet client 126. In both cases, the user must enter their WAC to access (i.e., unlock) the mobile wallet client 126. After the mobile wallet client 126 is unlocked, the user can select the payment method. In some arrangements, no selection is required if the user has configured a default payment method. When the payment method is selected, the mobile wallet client 126 optionally downloads the appropriate payment token and LUK from the financial institution computing system 104 (if the non-default payment method is selected). When the mobile wallet client 126 has the payment token and the LUK, the user taps the mobile device 124 at an NFC transceiver of the merchant POS terminal 128 to effectuate an NFC transfer of the token and the LUK to the merchant POS terminal 128. The merchant POS terminal 128 then transmits the received token and LUK to the payment network 118 for approval to proceed with the transaction in a similar manner that the merchant POS terminal 128 would transmit a normal card transaction authorization request. This process is described in further detail below with respect to the method 500 of FIG. 5.

Referring to FIG. 5, a flow diagram of a method 500 of executing a payment associated with a transaction via the mobile wallet system is shown according to an example embodiment. Various portions of the method 500 are performed by the mobile wallet client 126, the financial institution computing system 104, the payment network 118, and the merchant POS terminal 128. The method 500 is performed when the mobile wallet user attempts to pay a party (e.g., a retailer for a purchase) via the mobile wallet system.

The method 500 begins when the user is authenticated at 502. The user is preparing to make a payment to a merchant via the merchant POS terminal 128. The user wants to make the payment via the user's mobile wallet through the mobile device 124. The mobile device 124 is running the mobile wallet client 126. The user authenticates himself by providing either the online banking credentials or WAC to the mobile wallet client 126 via the mobile device 124. If the user provides the correct authentication information, the user is authenticated.

After authenticating himself, the user selects a payment method at 504. The user's mobile wallet may have a plurality of different payment sources (e.g., debit cards, credit cards, bank accounts, etc.). The user selects the payment source to be used by interacting with the mobile wallet client 126 on the mobile device 124. In some arrangements, the user's mobile wallet is setup with a default payment source. In such arrangements, 504 is skipped if the user wishes to proceed with payment via the default payment method. Accordingly, the mobile wallet client 126 receives a user selection of the payment source to be used for the payment.

The payment package is prepared for delivery at 506. The mobile wallet client 126 prepares (i.e., generates or creates) the payment package for delivery to the merchant POS terminal 128. The payment package is a file that is transmitted from the mobile device 124 to the merchant POS terminal 128. The file includes at least the token relating to the selected payment source and a token cryptogram that is formed at least in part on the LUK. The token cryptogram may be formed based on programming logic supplied by the payment network 118. In some arrangements, the payment package also includes a token expiration date for the payment token and a token requestor identification that identifies the financial institution 102 as the initial token requestor. If selected payment source is the default payment source, the payment token and LUK are stored locally within the memory of the mobile device 124. Accordingly, the mobile device 124 does not need to retrieve the payment token and LUK from the financial institution computing system 104. However, if the selected payment source is not the default payment source, the payment token and LUK need to be obtained from the financial institution computing system 104. Accordingly, prior to preparing the payment package, it may be necessary to request the appropriate payment token and LUK from the financial institution computing system 104 and to receive the payment token and LUK from the financial institution computing system 104. In some arrangements, the payment package is encrypted.

An NFC bump is detected at 508. The NFC bump is detected by the mobile wallet client 126 via the mobile device 124. The NFC bump relates to the user placing the mobile device 124 in proximity to the merchant POS terminal 128. When the NFC bump is detected, the payment package prepared at 506 is transmitted at 510. The payment package is transmitted from the mobile device 124 to the merchant POS terminal 128. In response to transmitting the payment package at 510, a terminal confirmation may be received at 512. The terminal confirmation is transmitted from the merchant POS terminal 128 to the mobile device 124 after receipt of the payment package. The terminal confirmation may be in the form of a handshake acknowledgement that informs the mobile device 124 that data was successfully passed during the NFC bump. After the payment package is transmitted, the payment package and transaction information is sent to the payment network 118 for approval. In some arrangements, the payment package is transmitted by the merchant POS terminal 128 to an acquirer that routes the payment package to the payment network 118. The payment network detokenizes the payment token and verifies the token cryptogram. If the token cryptogram is verified and the payment token is successfully detokinzed, the payment network 118 proceeds as though the transaction is a traditional credit or debit card transaction. Accordingly, the payment network 118 may request approval from the financial institution computing system 104 prior to approving the payment. The request for approval may include verifying that the account associated with the payment token is active and has enough remaining credit to proceed with the transaction.

A payment confirmation is received from either the financial institution 102 or the payment network 118 at 514. The payment confirmation relates to a confirmation that the payment source was accepted and that the transaction is approved or a payment denial message. The payment confirmation is received by the mobile device 124 and/or by the merchant POS terminal 128.

The above-described systems and methods provide for customer to merchant payments via NFC at a merchant POS terminal. The systems and methods utilize HCE and a payment network assigned payment token to effectuate payment in a similar manner as done with credit cards and debit cards without requiring the customer to present the physical card. Since the financial institution computing system 104 retrieves and stores the payment tokens from the payment network 118, the financial institution 102 has control over when the tokens are used and/or valid. This provides added benefits over mobile payment systems that allow for direct communication between the payment network 118 and the mobile device 124.

One advantage is that the system permits the financial institution 102, and thus the user, to set eligibility criteria for transactions. For example, the mobile wallet client 126 can be programmed to permit certain transactions or reject certain transactions based on certain eligibility criteria. The eligibility criteria may include a price limit. For example, the mobile wallet client 126 may reject transactions over a user set price limit. The eligibility criteria may include geographic limits, such as a geo-fenced area of permitted or restricted transactions. For example, the mobile wallet client 126 may deny an attempted transaction of a user attempting to make a purchase outside of a geo-fenced area of permitted transactions. The user associated with the mobile wallet client 126 can program the specific eligibility criteria for users of the mobile wallet.

Another advantage is that the system permits greater security of the user's financial information. By providing the additional layer of the mobile wallet client 126, any user attempting to pay for a purchase via the mobile device will also require knowledge of the user's WAC prior to being able to transmit the payment token. Further, only the default payment method token and LUK are stored on the mobile device 124. Other payment methods are stored in secure storage on the financial institution computing device 104.

The present disclosure contemplates methods, systems and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions. Software implementations could be accomplished with standard programming techniques with rule based logic and other logic to accomplish the various connection steps, processing steps, comparison steps and decision steps.

While this specification contains many specific implementation details, these should not be construed as limitations on the scope of what may be claimed, but rather as descriptions of features specific to particular implementations. Certain features described in this specification in the context of separate implementations can also be implemented in combination in a single implementation. Conversely, various features described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated in a single software product or packaged into multiple software products embodied on tangible media.

Thus, particular implementations of the subject matter have been described. Other implementations are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

The claims should not be read as limited to the described order or elements unless stated to that effect. It should be understood that various changes in form and detail may be made by one of ordinary skill in the art without departing from the spirit and scope of the appended claims. All implementations that come within the spirit and scope of the following claims and equivalents thereto are claimed.

1. A method of providing a user a mobile wallet account, the method comprising:
receiving, by a financial institution computing system, a registration request from a mobile device associated with the user;
creating, by the financial institution computing system, a mobile wallet account associated with the user;
receiving, by the financial institution computing system from the mobile device, a selection of a credit card of a plurality of credit cards as a default credit card;
receiving, by the financial institution computing system, information associated with the plurality of credit cards, the information including default credit card information associated with the default credit card of the user and non-default credit card information associated with a non-default credit card of the user;
receiving, by the financial institution computing system from the mobile device, an indication to refrain from importing information associated with a selected account of the plurality of credit cards, wherein the information associated with the plurality of credit cards does not include the information associated with the selected account based on the indication;
transmitting, by the financial institution computing system, the information associated with the plurality of credit cards to a payment network computing system;
receiving, by the financial institution computing system from the payment network computing system, a plurality of payment tokens and a plurality of limited use keys (LUKs), the plurality of payment tokens including a payment token for the default credit card associated with the mobile device, a payment token for the default credit card associated with a second mobile device, and a payment token for the non-default credit card, the plurality of LUKs including a LUK for the default credit card associated with the mobile device, a LUK for the default credit card associated with the second mobile device, and a LUK for the non-default credit card, wherein the payment token for the default credit card associated with the mobile device is different than the payment token for the default credit card associated with a second mobile device and wherein the LUK for the default credit card associated with the mobile device is different than the LUK for the default credit card associated with the second mobile device[SA1],
sending, by the financial institution computing system, the payment token for the default credit card associated with the mobile device and the LUK for the default credit card associated with the mobile device to the mobile device;
sending, by the financial institution computing system, the payment token for the default credit card associated with the second mobile device and the LUK for the default credit card associated with the second mobile device to the second mobile device;
storing, by the financial institution computing system, the payment token for the non-default credit card and the LUK for the non-default credit card within a mobile wallet database of the financial institution computing system;
receiving, by the financial institution computing system, a request for the stored payment token for the non-default credit card and the stored LUK for the non-default credit card from the mobile device;
sending, by the financial institution computing system, the stored payment token for the non-default credit card and the stored LUK for the non-default credit card to the mobile device based on the request from the mobile device;
receiving, by the financial institution computing system, an indication of logging on to the mobile wallet account that triggers a LUK refresh;
determining, by the financial institution computing system based on the triggered LUK refresh, that the LUK for the default credit card associated with the mobile device and the LUK for the non-default credit card has been used for a set amount of time or a set number of uses and are expired;
transmitting, by the financial institution computing system, a request to the payment network computing system for a new LUK for the default credit card associated with the mobile device and a new LUK for the non-default credit card;
receiving, by the financial institution computing system from the payment network computing system based on the request, the new LUK for the default credit card associated with the mobile device and the new LUK for the non-default credit card;
storing, by the financial institution computing system, the new LUK for the default credit card associated with the mobile device and the new LUK for the non-default credit card within the mobile wallet database;
determining, by the financial institution computing system, that the new LUK for the default credit card associated with the mobile device is associated with the default credit card; and
sending, by the financial institution computing system based on the determination that the new LUK for the default credit card associated with the mobile device is associated with the default credit card, the new LUK for the default credit card associated with the mobile device to the mobile device that replaces the LUK for the default credit card associated with the mobile device prior to the LUK for the default credit card being used in a mobile wallet transaction and refraining from sending the new LUK for the non-default credit card.

2. The method of claim 1, wherein receiving the information associated with a plurality of credit cards comprises pulling the information from an enterprise account database of the financial institution computing system maintaining the credit card account.

3. The method of claim 1, wherein receiving the information associated with a plurality of credit cards comprises receiving the default credit card information from the user via the mobile device.

4-21. (canceled)

22. The method of claim 1, wherein the default credit card information comprises a photo of the default credit card received from the user via the mobile device.

23. A method of providing a user a mobile wallet account, the method comprising:
receiving, by a financial institution computing system, a registration request from a mobile device associated with a user;
creating, by the financial institution computing system, a mobile wallet account associated with the user;
generating, by the financial institution computing system, a wallet access code (WAC) associated with the user;
storing, by the financial institution computing system, the WAC within a mobile wallet database of the financial institution computing system;
receiving, by the financial institution computing system, default credit card information associated with a default credit card of the user and non-default credit card information associated with a non-default credit card of the user;
transmitting, by the financial institution computing system, the default credit card information and the non-default credit information to a payment network computing system;
receiving, by the financial institution computing system from the payment network computing system, a first payment token associated with the default credit card and a first limited use key (LUK) associated with the default credit card and the mobile device, and a second payment token associated with the non-default credit card and a second limited use key (LUK) associated with the non-default credit card and the mobile device;
sending, by the financial institution computing system, the first payment token and the first LUK to the mobile device;
storing, by the financial institution computing system, the second payment token and the second LUK within the mobile wallet database of the financial institution computing system;
receiving, by the financial institution computing system, a wallet access code from the mobile device;
authenticating, by the financial institution computing system, the user by determining that the received wallet access code matches the WAC stored in the mobile wallet database;
receiving, by the financial institution computing system, a request for the stored second payment token and the stored second LUK from the mobile device;
sending, by the financial institution computing system, the stored second payment token and the stored second LUK to the mobile device based on the request from the mobile device based on the authentication;
determining, by the financial institution computing system, that the first LUK has been used for a set amount of time or a set number of uses and is expired; and
updating the first LUK by sending, by the financial institution computing system, an updated LUK to the mobile device that replaces the expired first LUK prior to the expired first LUK being used in a mobile wallet transaction.

24. The method of claim 23, wherein receiving the non-default credit card information comprises pulling the non-default credit card information from an enterprise account database of the financial institution computing system maintaining the credit card.

25. The method of claim 23, wherein receiving the default credit card information comprises receiving the default credit card information from the user via the mobile device.

26. The method of claim 23, wherein the default credit card information comprises a photo of the default credit card received from the user via the mobile device.

27. The method of claim 1, wherein the registration request further includes an identifier of the mobile device, the method further comprising:
pairing, by the financial institution computing system based on the device identifier, the mobile device with the user; and
registering, by the financial institution computing system the mobile device with the payment network.

28. The method of claim 1, wherein the registration request further includes an identifier of the mobile device further comprising:
generating, by the financial institution computing system based on the received registration request, a customer token specific to the user and a device token specific to the mobile device.

29. The method of claim 1, wherein the registration requires further comprises an identifier of the mobile device, the method further comprising:
registering, by the financial institution computing system based on the identifier of the mobile device, the mobile device with the payment network.
receiving, by the financial institution computing system, a second identifier of the second mobile device; and
registering, by the financial institution computing system based on the second identifier of the second mobile device, the second mobile device with the payment network.
